(19) United States
(12) Patent Application Publication
(10) Pub. No.: US 2026/0158680 A1
(43) Pub. Date: Jun. 11, 2026

(54) GRIPPER

(71) Applicants: HYUNDAI MOTOR COMPANY, SEOUL (KR); KIA CORPORATION, SEOUL (KR)

(72) Inventors: Geon Beom Lee, Hwaseong-si (KR); Yu Seung Shin, Hwaseong-si (KR); Byung Ho Yoon, Hwaseong-si (KR); Hyun Sik Sim, Hwaseong-si (KR)

(73) Assignees: HYUNDAI MOTOR COMPANY, SEOUL (KR); KIA CORPORATION, SEOUL (KR)

(21) Appl. No.: 19/179,509

(22) Filed: Apr. 15, 2025

(30) Foreign Application Priority Data
Oct. 21, 2024 (KR) 10-2024-0144384

(51) Int. Cl. B25J 15/10

(52) U.S. Cl. CPC B25J 15/10

(57) ABSTRACT

A gripper includes a shaft having a convex region having a convex shape formed on an outer surface of the shaft, a cam part having a space into which the shaft is inserted, the cam part being configured to be rotatable about the shaft, and at least one holding member coupled to one side of the cam part, in which the shaft is configured to be translationally movable in an extension direction of the shaft. A guide section is formed in the cam part, the convex region is inserted into the guide section, and the guide section has a width corresponding to the convex region. The guide section includes a straight guide section extending in one direction, and a curved guide section connected to one side end of the first straight guide section based on the extension direction and having a curved shape.

### CROSS REFERENCE TO RELATED APPLICATIONS

This application claims priority to and the benefit of Korean Patent Application No. 10-2024-0144384 filed in the Korean Intellectual Property Office on Oct. 21, 2024, the entire contents of which are incorporated herein by reference.

### TECHNICAL FIELD

The present disclosure relates to a gripper, and more particularly, to a gripper having a structure capable of grasping an object.

### BACKGROUND

A gripper, which is mounted at a distal end of a robot arm and performs operations such as grasping an object, should be equipped with kinematic structures capable of implementing various motions, and should also be equipped with power sources capable of providing power to the kinematic structures in order to allow the gripper to implement motions in various ways. For example, in order for the gripper to implement an operation of grasping an object and a rotational operation, both a motor configured to provide power required to grasp the object and a motor configured to provide power required to rotate the gripper need to be mounted in the gripper.

However, in the related art, because a large number of motors need to be mounted in a gripper that implements motions in various ways, there is a problem in that the overall volume and weight of the gripper are increased, and the costs required to manufacture the gripper are increased.

### SUMMARY

The present disclosure has been made in an effort to provide a gripper with a novel structure capable of implementing various motions by a single power source.

In order to achieve the above-mentioned object, one aspect of the present disclosure provides a gripper including a shaft having a convex region formed on an outer surface of the shaft, the convex region having a convex shape, a cam part having a space into which the shaft is inserted, the cam part being configured to be rotatable about the shaft, and one or more holding members coupled to one side of the cam part, in which the shaft is configured to be translationally movable in an extension direction D of the shaft, in which a guide section is formed in the cam part, the convex region is inserted into the guide section, and the guide section has a width corresponding to the convex region, and in which the guide section includes a straight guide section extending in one direction, and a curved guide section connected to one side end of the first straight guide section based on the extension direction D and having a curved shape.

When a direction of the extension direction D in which the holding member extends from the shaft is defined as a first extension direction D1, the curved guide section may be connected to an end of the first straight guide section based on the first extension direction D1.

The straight guide section may extend in parallel with the extension direction D.

The convex region may have a shape protruding outward from a body of the shaft.

The convex region may be formed as a plurality of convex regions provided in a circumferential direction of the outer surface of the shaft, and the straight guide section and the curved guide section may be respectively provided as a plurality of straight guide sections and a plurality of curved guide sections corresponding to the plurality of convex regions in a one-to-one manner.

The gripper may further include a guide member coupled to one side of the shaft, in which a through-hole penetrated by the holding member is formed in the guide member.

When a direction of the extension direction D in which the holding member extends from the shaft is defined as a first extension direction D1, the guide member may be fixedly coupled to an end of the shaft based on the first extension direction D1.

The guide member may include a guide extension region coupled to the shaft and extending in the extension direction D, and a guide accommodation region connected to one side of the guide extension region based on the first extension direction D1, having a plate shape, and having the through-hole.

The holding member may include a first grasping portion fixed to the cam part, and a second grasping portion extending from the first grasping portion and spaced apart from the cam part, and the second grasping portion may penetrate the through-hole.

When a direction of the extension direction D in which the holding member extends from the shaft is defined as a first extension direction D1, the second grasping portion may extend in the first extension direction D1 outward in a direction away from the shaft.

The curved guide section may have a three-dimensional spiral shape with a constant radius.

When a direction of the extension direction D in which the holding member extends from the shaft is defined as a first extension direction D1, the curved guide section may have a three-dimensional spiral shape having a radius that decreases in the first extension direction D1.

The holding member may include a first grasping portion fixed to the cam part, and a second grasping portion extending from the first grasping portion and spaced apart from the cam part, and the second grasping portion may be coupled to the first grasping portion and configured to be rotatable relative to the first grasping portion.

The straight guide section may include a first straight guide section, and a second straight guide section provided to be spaced apart from the first straight guide section, the first straight guide section may be connected to one side end of the curved guide section based on the extension direction D, and the second straight guide section may be connected to the other side end of the curved guide section based on the extension direction D.

The gripper may further include a housing configured to accommodate at least a partial region of the shaft, and a bearing provided at one side of the housing and provided to surround at least a partial region of the cam part, in which the bearing is provided between the cam part and the housing.

The gripper may further include a motor connected to one side of the shaft and configured to provide power required for the translational motion of the shaft.

According to the present disclosure, it is possible to manufacture the gripper with a novel structure capable of implementing various motions by means of the single power source.

### BRIEF DESCRIPTION OF THE FIGURES

FIG. 1 is a perspective view of a gripper according to the present disclosure.

FIG. 2 is a cross-sectional view of the gripper according to the present disclosure.

FIG. 3 is a perspective view illustrating a state in which a housing in FIG. 1 is excluded.

FIG. 4 is a perspective view of a shaft provided in the gripper according to the present disclosure.

FIG. 5 is a perspective view of a cam part provided in the gripper according to the present disclosure.

FIG. 6 is a view illustrating a cross-sectional structure of the cam part provided in the gripper according to the present disclosure.

FIG. 7 is a perspective view illustrating another example of the cam part provided in the gripper according to the present disclosure.

FIG. 8 is a perspective view illustrating another example of a holding member provided in the gripper according to the present disclosure.

### DETAILED DESCRIPTION

Hereinafter, a gripper according to the present disclosure will be described with reference to the drawings.

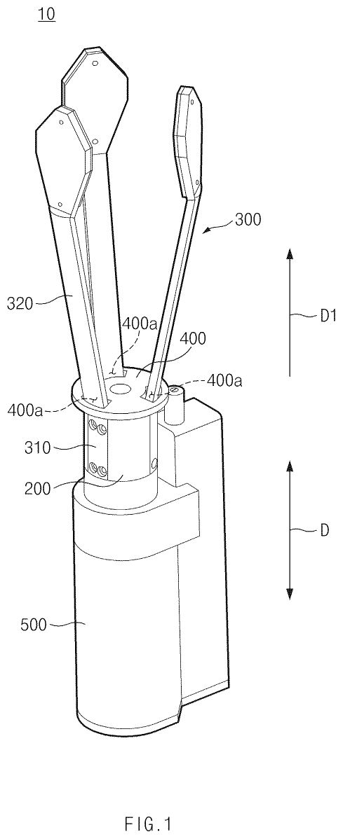

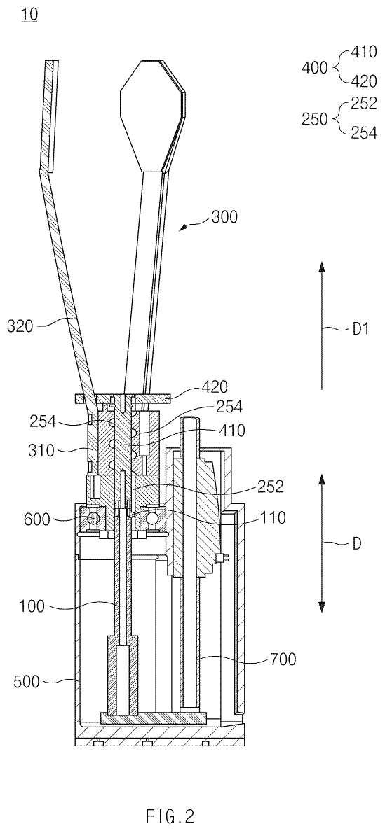

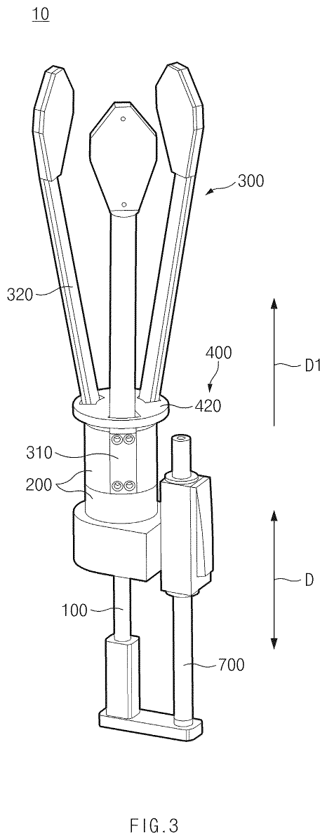

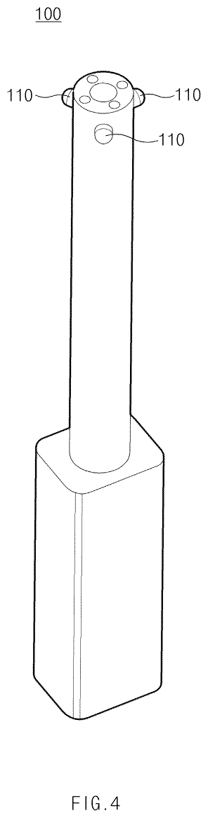

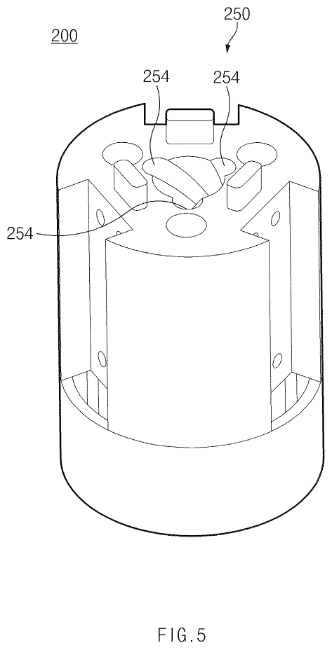

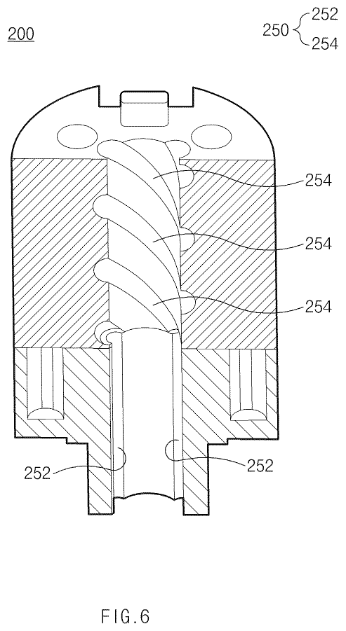

FIG. 1 is a perspective view of a gripper according to the present disclosure, and FIG. 2 is a cross-sectional view of the gripper according to the present disclosure. FIG. 3 is a perspective view illustrating a state in which a housing in FIG. 1 is excluded, and FIG. 4 is a perspective view of a shaft provided in the gripper according to the present disclosure. FIG. 5 is a perspective view of a cam part provided in the gripper according to the present disclosure, and FIG. 6 is a view illustrating a cross-sectional structure of the cam part provided in the gripper according to the present disclosure.

The gripper according to the present disclosure may serve to grasp an object. For example, the gripper may be provided in a distal end region of a robot arm. In particular, as described below, the gripper according to the present disclosure is characterized by implementing complex motions by using a single power source.

With reference to FIGS. 1 to 3, a gripper 10 according to the present disclosure may include a shaft 100 having a plurality of convex regions 110 formed on an outer surface of the shaft 100, the convex region 110 having a convex shape. More specifically, the convex region 110 may be provided as a plurality of convex regions 110 provided in a circumferential direction of the outer surface of the shaft 100. For example, as illustrated in FIGS. 2 and 4, the convex region 110 may have a shape protruding outward from a body of the shaft 100. Three convex regions 110 may be provided at equal intervals in the circumferential direction of the outer surface of the shaft 100.

In addition, the gripper 10 according to the present disclosure may further include a cam part 200 having a space into which the shaft 100 is inserted, the cam part 200 being configured to be rotatable about the shaft 100. That is, the shaft 100 may be inserted into the cam part 200, and the convex region 110 may be accommodated in the internal space of the cam part 200. As described below, the cam part 200 may be rotated by interference between an inner surface of the cam part and the convex region 110 during a translational motion of the shaft 100.

With continued reference to FIGS. 1 to 3, the gripper 10 according to the present disclosure may include one or more holding members 300 coupled to one side of the cam part 200. More specifically, the holding member 300 may be fixedly coupled to the cam part 200. Therefore, in case that the cam part 200 rotates, the holding member 300 may also rotate together with the cam part 200.

Meanwhile, with reference to FIGS. 1 to 3, 5, and 6, the shaft 100 according to the present disclosure may be configured to be translationally movable in an extension direction D (a vertical direction based on FIGS. 1 to 3) of the shaft. The cam part 200 may have guide sections 250 each having a space with a width corresponding to the convex region 110 so that the convex regions 110 are inserted into the guide sections 250. The guide section 250 may be formed in an inner surface of the cam part 200. More specifically, the guide section 250 may be formed in the inner surface of the cam part 200 that defines the space in which the shaft 100 is inserted into the cam part 200. For example, in case that the convex region 110 has a protruding shape, the guide section 250 may have a shape recessed in the inner surface of the cam part 200 in a direction away from the shaft, as illustrated in FIG. 6. In this case, the convex region 110 may be accommodated in the space defined by the guide section 250.

Meanwhile, according to the present disclosure, the guide section 250 may include a plurality of sections with different geometric characteristics. More specifically, with reference to FIG. 6, the guide section 250 may include first straight guide sections 252 extending in one direction, and curved guide sections 254 each connected to one side end of each of the first straight guide sections 252 based on the extension direction D and having a curved shape.

According to the present disclosure, in case that the shaft 100 performs the translational motion in the extension direction D, the convex region 110 may also perform the translational motion in the extension direction D, and the motion of the cam part 200 may vary depending on which portions of the guide section 250 the convex region 110 passes over. More specifically, during the process in which the shaft 100 performs the translational motion in the extension direction D, i) the cam part 200 may be stationary in case that the convex region 110 passes over the first straight guide section 252, and ii) the cam part 200 may rotate about the shaft 100 when the convex region 110 passes over the curved guide section 254.

Meanwhile, when a direction (upward direction based on FIGS. 1 to 3) of the above-mentioned extension direction D, in which the holding member 300 extends from the shaft 100, is defined as a first extension direction D1, the curved guide section 254 may be connected to an end of the first straight guide section 252 based on the first extension direction D1. According to the present disclosure, the convex region 110 may be positioned in the first straight guide section 252 in an initial state made before the gripper 10 performs the operation of grasping the object. Therefore, when the shaft 100 begins to perform the translational motion in the initial state, the convex region 110 may pass over the curved guide section 254 after the convex region 110 passes over the first straight guide section 252. More particularly, with reference to FIGS. 1 to 3 and 4, the first straight guide section 252 may extend in parallel with the extension direction D. In addition, as described above, the plurality of convex regions 110 may be provided in the circumferential direction of the outer surface of the shaft 100. Therefore, the plurality of first straight guide sections 252 and the plurality of curved guide sections 254 may be provided to correspond to the plurality of convex regions 110 in a one-to-one manner. That is, according to the present disclosure, the convex regions 110 may each pass over only one first straight guide section and only one curved guide section among the plurality of first straight guide sections 252 and the plurality of curved guide sections 254, and the first straight guide section 252 and the curved guide section 254 may accommodate only one convex region 110.

With continued reference to FIGS. 1 to 3, the gripper 10 according to the present disclosure may further include a guide member 400 coupled to one side of the shaft 100. More specifically, the guide member 400 may be fixedly coupled to the shaft 100. As illustrated in FIGS. 1 to 3, the guide member 400 may be fixedly coupled to the end of the shaft 100 based on the first extension direction D1. Meanwhile, through-holes 400a may be formed in the guide member 400, and the holding members 300 may penetrate the through-holes 400a. The holding member 300 may penetrate the guide member 400 through the through-hole 400a.

According to the present disclosure, the guide member 400 may serve to allow the holding members 300 to retract to grasp the object while the guide member 400 performs the translational motion together with the shaft 100 during the translational motion of the shaft 100.

The above-mentioned operation, the holding member may include a plurality of portions. More specifically, as illustrated in FIGS. 1 to 3, the holding member 300 may include a first grasping portion 310 fixed to the cam part 200, and a second grasping portion 320 extending from the first grasping portion 310 and spaced apart from the cam part 200 in the first extension direction D1. In this case, the second grasping portion 320 may be provided to penetrate the through-hole 400a of the guide member 400. More particularly, the first grasping portion 310 may extend parallel to the first extension direction D1, and the second grasping portion 320 may extend in the first extension direction D1 outward in a direction away from the shaft 100. Therefore, according to the present disclosure, when the shaft 100 performs the translational motion in the first extension direction D1 in the above-mentioned initial state, i) the guide member 400 fixedly coupled to the shaft 100 is also moved in the first extension direction D1, and ii) the second grasping portions 320 inserted into the through-holes 400a of the guide member 400 are moved inward by interference between the guide member 400 and the second grasping portions 320, such that the operation of retracting the holding members 300 may be implemented. Thereafter, when the convex regions 110 pass over the first straight guide sections 252 and enter the curved guide sections 254, the cam part 200 rotates about the shaft 100, as described above. That is, according to the present disclosure, both the retraction operations of the holding members and the rotations of the holding members may be implemented by the translational motion of the shaft 100. Meanwhile, as illustrated in FIGS. 1 to 3, for example, the guide member 400 may include a guide extension region 410 coupled to the shaft 100 and extending in the extension direction D, and a guide accommodation region 420 connected to one side of the guide extension region 410 based on the first extension direction D1, having a plate shape, and having the above-mentioned through-holes 400a.

Meanwhile, with reference to FIG. 5, the curved guide section 254 of the guide section 250 in the cam part 200 may have a three-dimensional spiral shape. More specifically, the shaft 100 may be defined as a central axis, and the curved guide section 254 may have a three-dimensional spiral shape surrounding the central axis. As illustrated in FIG. 5, the curved guide section 254 may have a three-dimensional spiral shape with a constant distance, i.e., a constant radius from the central axis. However, in an alternate embodiment, unlike the configuration illustrated in FIG. 5, the curved guide section 254 may have a three-dimensional spiral shape having a radius that decreases in the first extension direction D1. In this case, the holding members 300 may consistently retract even during the process in which the cam part 200 rotates, such that the holding members 300 may more effectively grasp the object. Meanwhile, in case that the curved guide section 254 has the three-dimensional spiral shape, a pitch of a spiral structure may be constant, as illustrated in FIG. 6. However, the pitch may be variable.

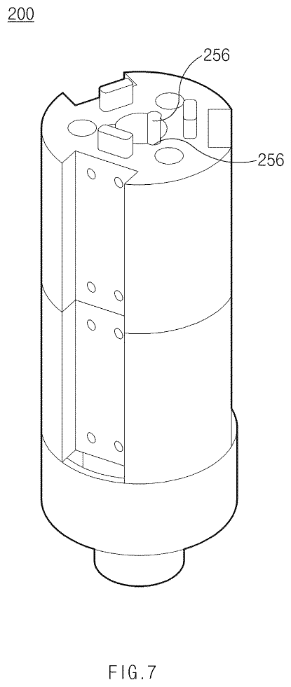

FIG. 7 is a perspective view illustrating another example of the cam part provided in the gripper according to the present disclosure.

The cam part provided in the gripper according to another example of the present disclosure may include the structure of the cam part 200 illustrated in FIGS. 5 and 6 in an intact manner and additionally include the features described below.

More specifically, as illustrated in FIG. 7, a straight guide section may be additionally provided in the guide section 250 of the cam part 200 according to the present disclosure, in addition to the first straight guide section. That is, with reference to FIGS. 6 and 7, the guide section 250 may further include second straight guide sections 256 spaced apart from the first straight guide sections 252, in addition to the first straight guide sections 252 and the curved guide sections 254. In this case, with reference to FIGS. 1 to 3, 6, and 7, the first straight guide section 252 may be connected to one side end of the curved guide section 254 based on the extension direction D, and the second straight guide section 256 may be connected to the other side end of the curved guide section 254 based on the extension direction D. According to the cam part 200 illustrated in FIG. 7, the holding members 300 of the gripper 10 according to the present disclosure may i) retract when the convex regions 110 pass over the first straight guide sections 252, ii) rotate together with the cam part 200 when the convex regions 110 pass over the curved guide sections 254, and iii) and retract again when the convex regions 110 pass over the second straight guide sections 256, such that more complex motions of the holding members 300 may be implemented.

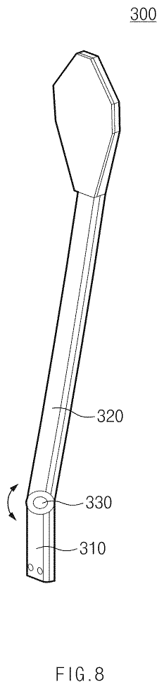

FIG. 8 is a perspective view illustrating another example of the holding member provided in the gripper according to the present disclosure.

Meanwhile, according to the present disclosure, the first grasping portion 310 and the second grasping portion 320 of the holding member 300 may be configured to be rotatable relative to each other. More specifically, the holding member 300 may include the first grasping portion 310 fixed to the cam part 200, and the second grasping portion 320 extending from the first grasping portion 310 and spaced apart from the cam part 200. The second grasping portion 320 may be coupled to the first grasping portion 310 and configured to be rotatable relative to the first grasping portion 310. For example, the holding member 300 may include a rotary shaft 330 provided in a region in which the first grasping portion 310 and the second grasping portion 320 are coupled. The first grasping portion 310 and the second grasping portion 320 may be configured to be rotatable about the rotary shaft 330.

Meanwhile, as illustrated in FIGS. 1 to 3, the gripper 10 according to the present disclosure may further include a housing 500 configured to accommodate at least a partial region of the shaft 100, and a bearing 600 provided at one side of the housing 500 and provided to surround at least a partial region of the cam part 200. The bearing 600 may be configured to support the cam part 200 so that the cam part 200 may smoothly move. For example, the bearing 600 may be provided between the cam part 200 and the housing 500 and have one side fixedly coupled to the housing 500.

In addition, the gripper 10 according to the present disclosure may further include a motor 700 connected to one side of the shaft 100 and configured to provide power required for the translational motion of the shaft 100. For example, the motor 700 may be a linear motor. According to the present disclosure, the complex motion of the holding member 300 may be implemented by the single motor 700.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

1. A gripper comprising:
a shaft having a convex region having a convex shape formed on an outer surface of the shaft;
a cam part having a space into which the shaft is inserted, the cam part being configured to be rotatable about the shaft; and
at least one holding member coupled to one side of the cam part;
wherein the shaft is configured to be translationally movable in a first extension direction of the shaft;
wherein a guide section is formed in the cam part, the convex region is configured to be inserted into the guide section, and the guide section has a width corresponding to the convex region; and
wherein the guide section comprises:
a straight guide section extending in one direction; and
a curved guide section connected to one side end of the straight guide section based on the first extension direction, and having a curved shape.

2. The gripper of claim 1, wherein when a direction of the first extension direction in which the at least one holding member extends from the shaft is defined as a second extension direction, and wherein the curved guide section is connected to an end of the straight guide section based on the second extension direction.

3. The gripper of claim 1, wherein the straight guide section is parallel to the first extension direction.

4. The gripper of claim 1, wherein the convex region protrudes outwardly from a body of the shaft.

5. The gripper of claim 1, wherein the convex region comprises a plurality of convex regions provided in a circumferential direction of the outer surface of the shaft, the straight guide section comprises a plurality of straight guide sections, and the curved guide section comprises a plurality of curved guide sections each corresponding to each of the plurality of convex regions.

6. The gripper of claim 1, further comprising
a guide member coupled to one side of the shaft,
wherein a through-hole penetrated by the at least one holding member is formed in the guide member.

7. The gripper of claim 6, wherein when a direction of the first extension direction in which the at least one holding member extends from the shaft is defined as a second extension direction, the guide member is fixedly coupled to an end of the shaft based on the second extension direction.

8. The gripper of claim 7, wherein the guide member comprises:
a guide extension region coupled to the shaft and extending in the first extension direction; and
a guide accommodation region connected to one side of the guide extension region based on the second extension direction, having a plate shape, and having the through-hole.

9. The gripper of claim 6, wherein the at least one holding member comprises:
a first grasping portion fixed to the cam part; and
a second grasping portion extending from the first grasping portion and spaced apart from the cam part;
wherein the second grasping portion penetrates the through-hole.

10. The gripper of claim 9, wherein when a direction of the first extension direction in which the at least one holding member extends from the shaft is defined as a second extension direction, the second grasping portion extends in the second extension direction outwardly away from the shaft.

11. The gripper of claim 1, wherein the curved guide section has a three-dimensional spiral shape with a constant radius.

12. The gripper of claim 1, wherein when a direction of the first extension direction in which the at least one holding member extends from the shaft is defined as a second extension direction, the curved guide section has a three-dimensional spiral shape having a radius that decreases in the second extension direction.

13. The gripper of claim 6, wherein the at least one holding member comprises:
a first grasping portion fixed to the cam part; and
a second grasping portion extending from the first grasping portion and spaced apart from the cam part;
wherein the second grasping portion is coupled to the first grasping portion and configured to be rotatable relative to the first grasping portion.

14. The gripper of claim 1, wherein the straight guide section comprises:
a first straight guide section; and
a second straight guide section spaced apart from the first straight guide section;
wherein the first straight guide section is connected to one side end of the curved guide section based on the first extension direction; and
wherein the second straight guide section is connected to an other side end of the curved guide section based on the first extension direction.

15. The gripper of claim 1, further comprising:
a housing configured to accommodate at least a partial region of the shaft; and
a bearing positioned at one side of the housing, and surrounding at least a partial region of the cam part;
wherein the bearing is positioned between the cam part and the housing.

16. The gripper of claim 1, further comprising:
a motor connected to one side of the shaft and configured to provide power for translational motion of the shaft.

17. The gripper of claim 1, wherein the at least one holding member comprises three holding members.

18. The gripper of claim 1, wherein the at least one holding member comprises:
a first grasping portion; and
a second grasping portion extending from the first grasping portion;
wherein the second grasping portion is rotatably coupled to the first grasping portion.
